(19) United States
(12) Patent Application Publication
(10) Pub. No.: US 2022/0354146 A1
(43) Pub. Date: Nov. 10, 2022

(54) INTERCONNECTING EDIBLE ARTICLES

(71) Applicant: ANNIE MAK, NEW YORK, NY (US)

(72) Inventor: ANNIE MAK, NEW YORK, NY (US)

(21) Appl. No.: 17/313,695

(22) Filed: May 6, 2021

(51) Int. Cl. A23G 3/50

(52) U.S. Cl. CPC A23G 3/50

(57) ABSTRACT

The present invention provides an assembly of edible articles, more specifically, which by virtue of their composition are able to form complex frameworks in usage of two or more of such embodiments to interconnect. The complexity of structures reflects upon the imagination of the user.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND FIELD

The present invention relates generally to an edible article that provides play value to the public market. More specifically, the present invention relates to the edible article comprising singular and plurality of the individual edible articles that may be arranged by patrons in formation of infinite or nonfinite, simple to complex frameworks.

### BACKGROUND PRIOR ART

The following is a tabulation of some prior art that presently appears relevant:

U.S. Patent Application Publications

| Publication Nr. | Kind Code | Publ. Date | Applicant |
|---|---|---|---|
| 20080171111 | A1 | 2008 Jul. 17 | Matsumoto |
| 20050191405 | A1 | 2005 Sep. 1 | Okos et al. |
| 20060003055 | A1 | 2006 Jan. 5 | Witkowski |
| 20030152668 | A1 | 2003 Aug. 14 | Griffin |
| 20060286284 | A1 | 2006 Dec. 21 | Mistry et al. |

Generally, edible articles, confectionaries, and food products are meant to be eaten by the consumer with favorable reasons in its flavors, shapes, sizes, and contents contained within. The previous edible articles, confectionaries, and food products with play value or toy-like activities similar to puzzle-like experiences were issued by U.S. Patent, although here are the disadvantages mentioned in each listed publication.

Japan Patent 301633 (2007), U.S. Pat. No. 0,171,111 (2008) issued to Matsumoto discloses confectionery as well as toys are unable to build complex structures with interlocking mechanisms. There are no outlets to create in continuity to an increasingly complex structure. The confectionery toy pieces are designed with simplicity to limiting one's ability to translate the imagination of the creator's mind. The designs are limited to its purpose and unable to extend beyond its scope, unlike the present invention.

U.S. Pat. No. 0,191,405 (2005) issued to Okos et al. discloses starch-molded fruit snack confectionery puzzles are designed for users to arrange into recognizable structures. The designs lack perpendicular interlocking mechanisms due to limitations in abilities of starch-molded gummies. Users are unable to form three-dimensional structures infinitely due to two-dimensional tabletop design pieces. Henceforth, contained in this patent application, the design and materials mentioned to produce the confectionery pieces are limiting in forming complex structures, unlike the present invention.

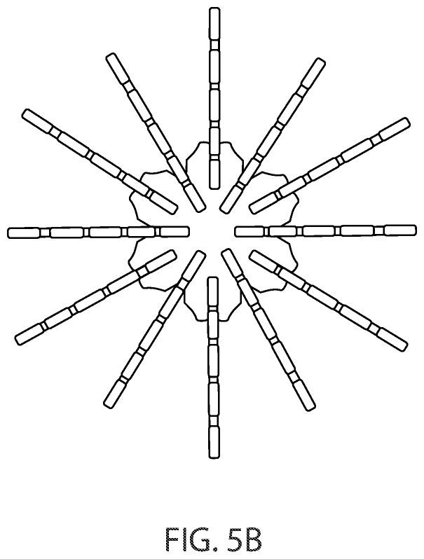

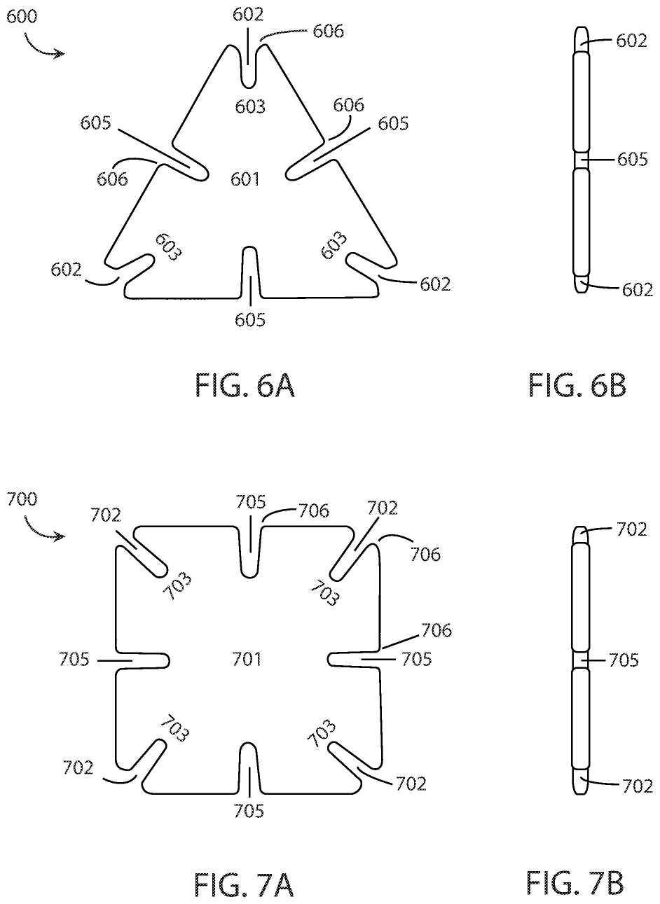

U.S. Pat. No. 0,152,668 (2003) issued to Griffin discloses an interlocking three-dimensional confectionery puzzle pieces are designed as hard candy and are unable to form complex structures based on the concept of multitudes. The block pieces in FIGS. 5 and 6 by default offers the public to interlock in four directions; east, south, west, and north, yet they are unable to interconnect diagonally from directions or southeast, southwest, northwest, and northeast. All the interconnecting puzzle pieces are designed to fit and play in the mouth forming into one piece. The concept of infiniteness is absent in all its designs, unlike the present invention.

U.S. Pat. No. 0,003,055 (2006) issued to Witkowski discloses linking articles has only interlocking mechanisms from zero to two ends. It is lacking varieties for an advance building confectionary structures. Its “U” shaped and jigsaw puzzle interlocking mechanisms are weak in solid locking plurality of the embodiments, designed for easy breakage and weak latching or gripping. Hence, Witkowski's flour-based products in interconnecting mechanisms offers instability of plurality of the embodiments, unlike the present invention.

U.S. Pat. No. 0,286,284 (2006) issued to Mistry et al. discloses worm-like candies that comprises a non-slit interlocking system in shapes of curved “C” or “U” confectioneries composed of gelatin gummy product that is flexible, stretchable, and are incapable to hold a solid form in singularity or plurality of the embodiments, unlike the present invention.

### SUMMARY

The present device provides an edible article for providing play value to consumers. The edible article comprises a plurality of individual, edible article pieces having various complementary configurations such that the edible articles can be arranged as a puzzle to form an increasingly complex and recognizable structure. Each of the plurality of edible article pieces are tools to articulate ideas and concepts into art.

### Background Advantages

The present device relates generally to edible articles that provides play value to patrons. More specifically, the present device relates to edible articles comprising a plurality of individual edible pieces that can be arranged by patrons as a puzzle to form increasingly complex and recognizable structures. The edible novelty products of the invention may include, e.g., games, toys, novelties, amusements, linking articles, puzzle pieces, Words, gas-producing compositions, etc.

### BRIEF DESCRIPTION OF THE INVENTION

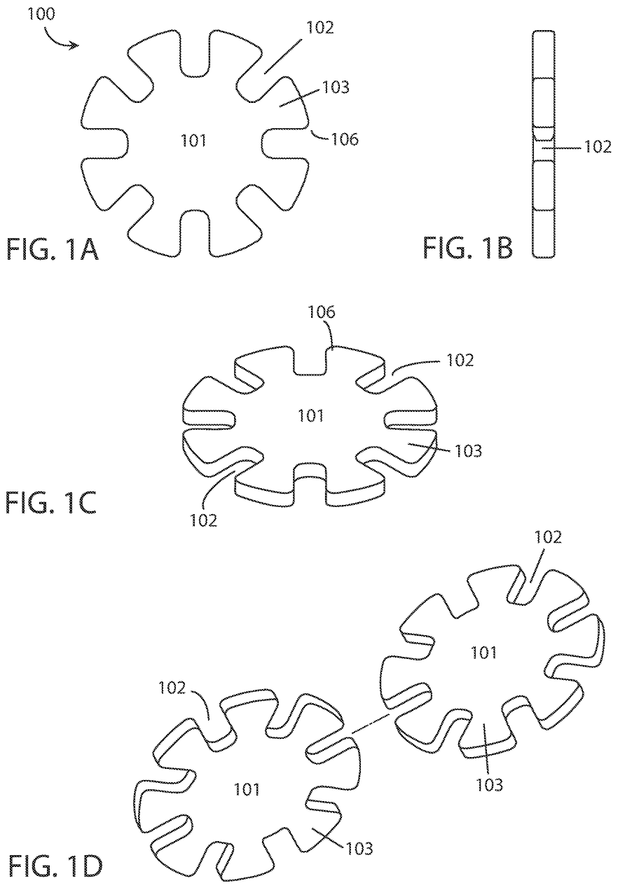

FIG. 1A ISA PLAN VIEW OF THE FIRST EMBODIMENT.

FIG. 1B ISA SIDE VIEW OF THE FIRST EMBODIMENT.

FIG. 1C IS THE PERSPECTIVE VIEW OF THE FIRST EMBODIMENT.

FIG. 1D IS THE PERSPECTIVE VIEW OF THE FIRST EMBODIMENT IN EXPLODED FORM;

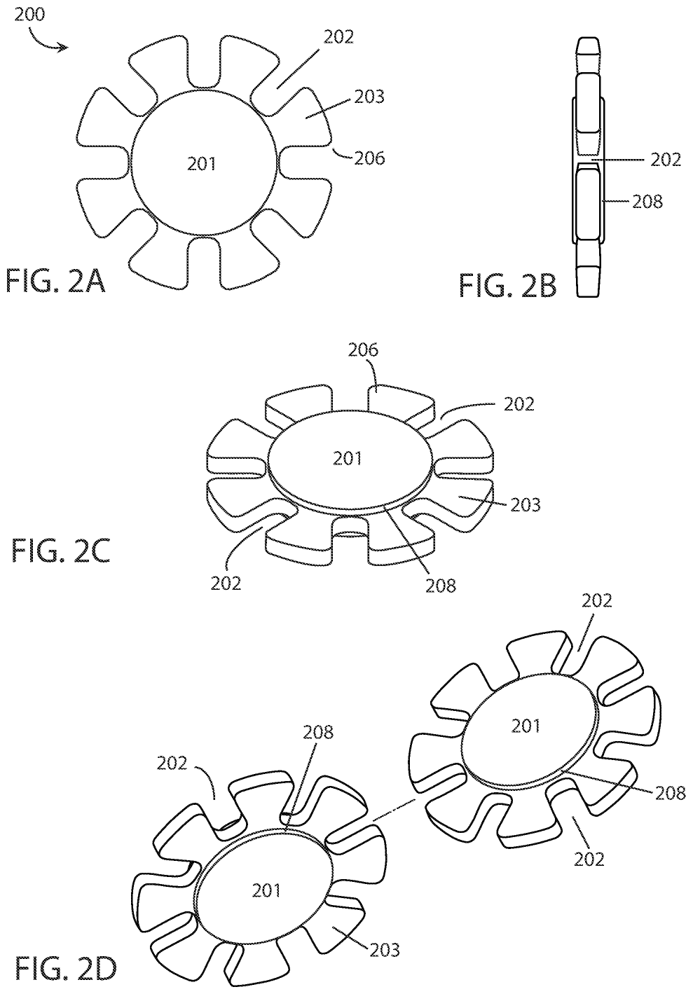

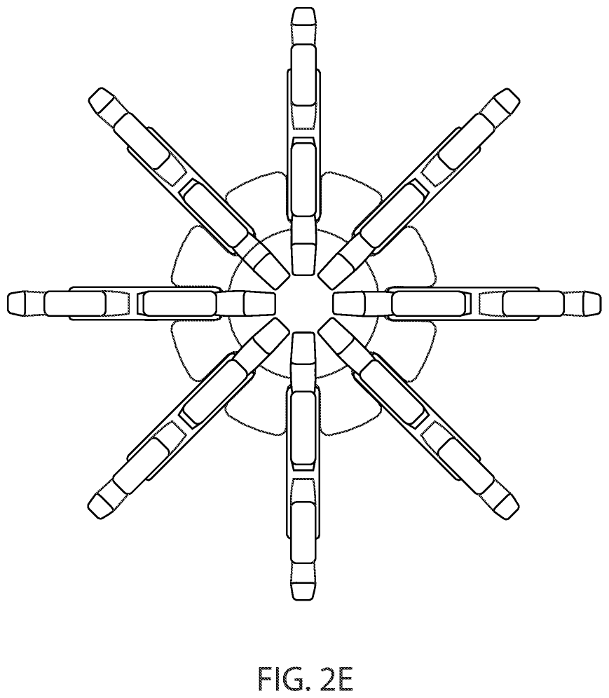

FIG. 2A ISA PLAN VIEW OF THE SECOND EMBODIMENT;

FIG. 2B ISA SIDE VIEW OF THE SECOND EMBODIMENT;

FIG. 2C IS THE PERSPECTIVE VIEW OF THE SECOND EMBODIMENT;

FIG. 2D IS THE PERSPECTIVE VIEW OF THE SECOND EMBODIMENT IN EXPLODED FORM;

FIG. 2E IS AN ASSEMBLED VIEW WHICH DEPICTS A PLURALITY OF SECOND EMBODIMENT LINKED TO FORM AN EXAMPLE CONFIGURATION;

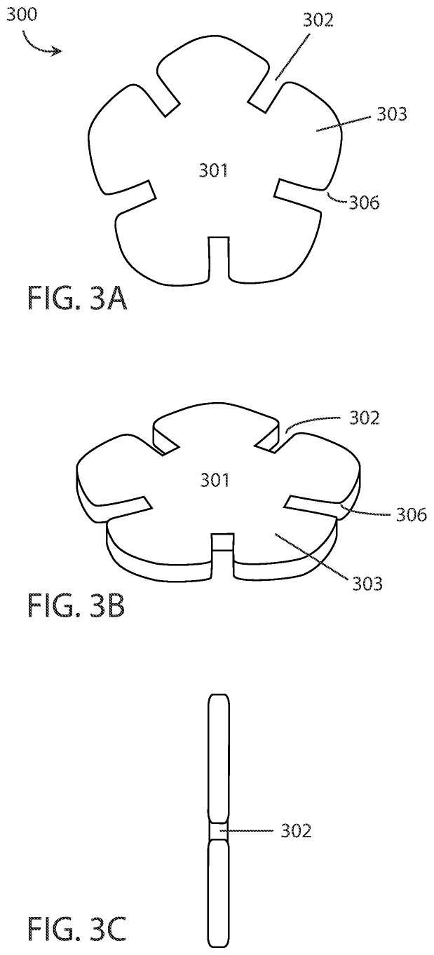

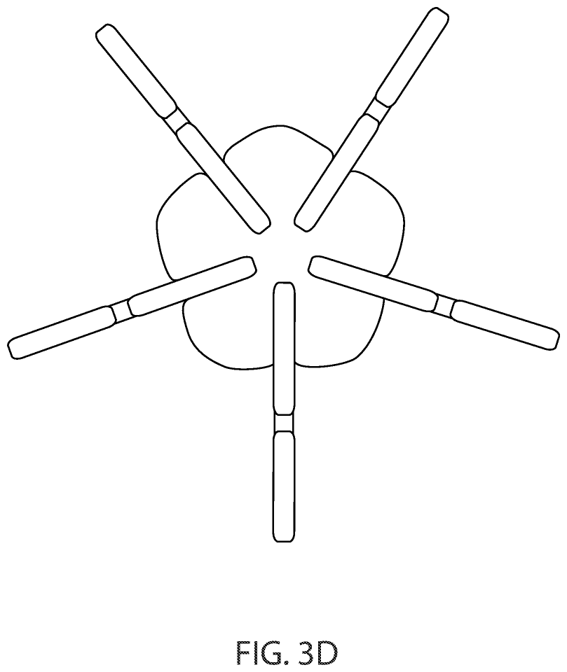

FIG. 3A ISA PLAN VIEW OF THE THIRD EMBODIMENT;

FIG. 3B ISA PERSPECTIVE VIEW OF THE THIRD EMBODIMENT;

FIG. 3C ISA SIDE VIEW OF THE THIRD EMBODIMENT;

FIG. 3D IS AN ASSEMBLED VIEW WHICH DEPICTS A PLURALITY OF THIRD EMBODIMENT LINKED TO FORM AN EXAMPLE CONFIGURATION;

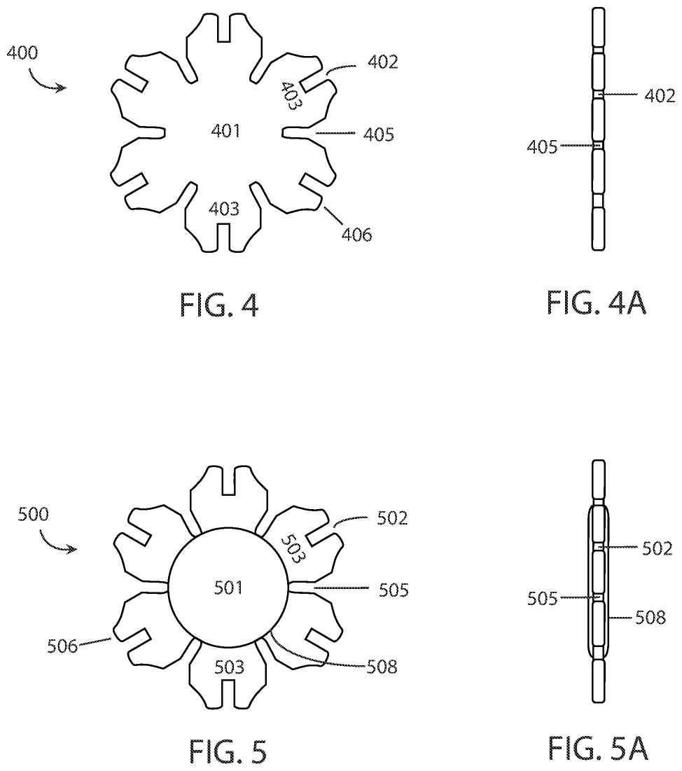

FIG. 4 ISA PLAN VIEW OF THE FOURTH EMBODIMENT;

FIG. 4A ISA SIDE VIEW OF FOURTH EMBODIMENT;

FIG. 5 IS A PLAN VIEW OF THE FIFTH EMBODIMENT;

FIG. 5A ISA SIDE VIEW OF THE FIFTH EMBODIMENT;

FIG. 5B IS AN ASSEMBLED VIEW WHICH DEPICTS A PLURALITY OF FIFTH EMBODIMENT LINKED TO FORM AN EXAMPLE CONFIGURATION;

FIG. 6A IS A PLAN VIEW OF THE SIXTH EMBODIMENT;

FIG. 6B ISA SIDE VIEW OF THE SIXTH EMBODIMENT;

FIG. 7A ISA PLAN VIEW OF THE SEVENTH EMBODIMENT;

FIG. 7B ISA SIDE VIEW OF THE SEVENTH EMBODIMENT;

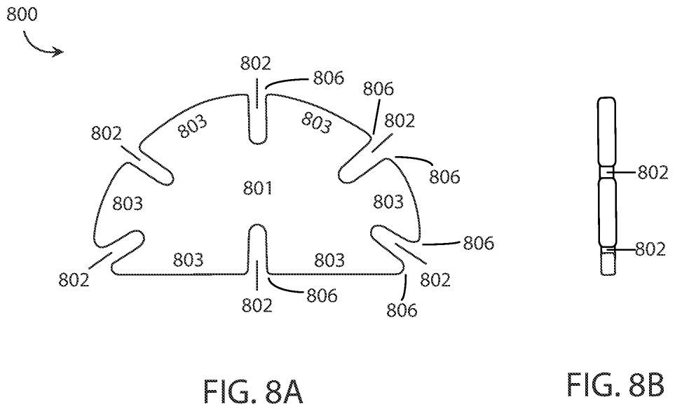

FIG. 8A IS A PLAN VIEW OF THE EIGHTH EMBODIMENT;

FIG. 8B IS A SIDE VIEW OF THE EIGHTH EMBODIMENT;

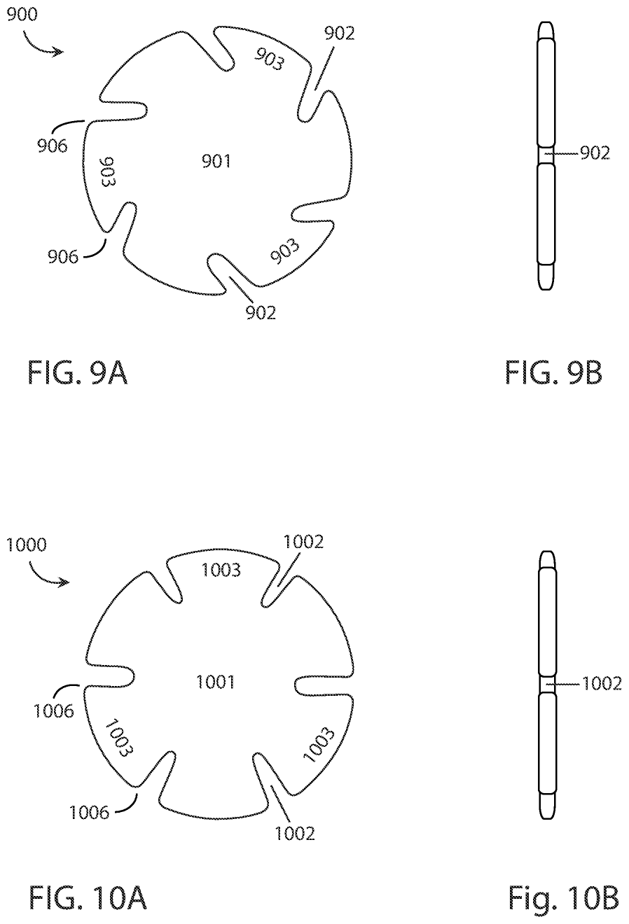

FIG. 9A IS A PLAN VIEW OF THE NINTH EMBODIMENT;

FIG. 9B IS A SIDE VIEW OF THE NINTH EMBODIMENT;

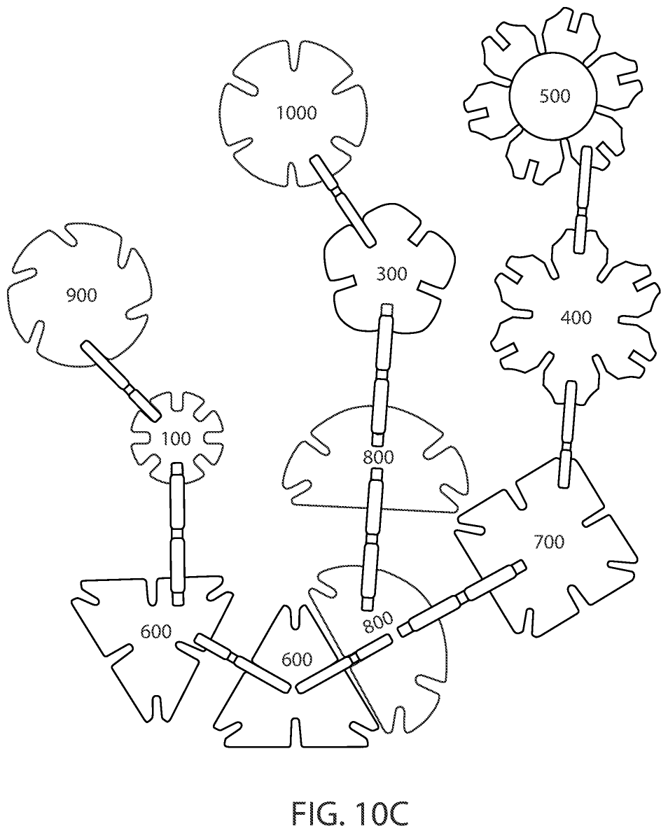

FIG. 10A ISA PLAN VIEW OF THE TENTH EMBODIMENT;

FIG. 10B ISA SIDE VIEW OF THE TENTH EMBODIMENT;

FIG. 10C IS AN ASSEMBLED VIEW DEPICTS A PLURALITY OF FIRST TO TENTH EMBODIMENTS LINKED TOGETHER IN ACCORDANCE WITH THIS DISCLOSURE.

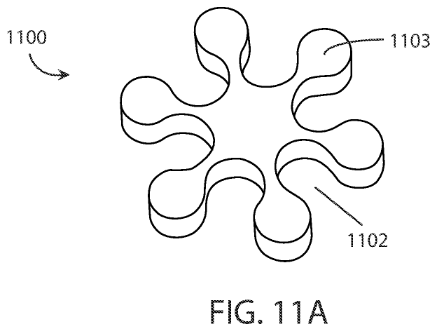

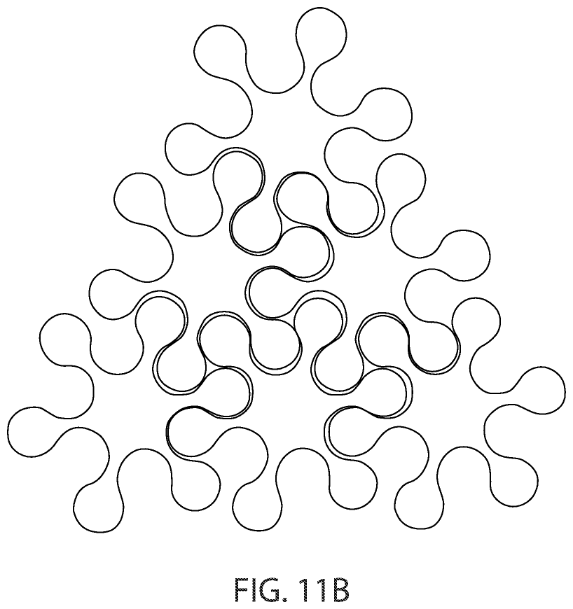

FIG. 11A IS A PERSPECTIVE VIEW OF THE ELEVENTH EMBODIMENT; AND

FIG. 11B is A PLAN VIEW WHICH DEPICTS A PLURALITY OF ELEVENTH EMBODIMENT LINKED TO FORM AN EXAMPLE CONFIGURATION.

### DRAWINGS—DESCRIPTION OF REFERENCE NUMERALS

100, 200, 300, 400, 500, 600, 700, 800, 900, 1000, 1100: Edible articles
101, 201, 301, 401, 501, 601, 701, 801, 901, 1001: Centers of edible articles
208, 508: Centered-disc elevated edges
103, 203, 303, 403, 503, 603, 705, 803, 903, 1003, 1103: Tabs
102, 202, 302, 402, 405, 502, 505, 602, 605, 702, 705, 802, 902, 1002: Slits
1102: Slot
106, 206, 306, 406, 506, 606, 706, 806, 906, 1006: Corners of Tabs

### DETAILED DESCRIPTION OF THE INVENTION—FIGS. 1 TO 11

The present invention provides an assembly of edible articles, more specifically, which by virtue of their composition are able to form complex frameworks in usage of two or more of such embodiments to interconnect. The complexity of structures reflects upon the imagination of the user.

One food piece is partially or entirely engageable with another piece, or one piece is engageable with a plurality of pieces, or a plurality of pieces are engageable with one another. The present invention also provides an integral assembly of a plurality of food pieces which are integrally coupled together but separable from each other.

First embodiment of the functions in edible article 100 is a shape of a disc-like flower with slits depicted in FIGS. 1A through 1D are able to interconnect on all permitting eight directions repeatedly in FIG. 2E, slit 102 mating with slit 102 at center of edible articles 101 without interference. While slit 102 to slit 102 interconnections are proper, the user is also permitted to use alternative methodologies of interconnection with slit 102 to tab 103 relationships.

Second embodiment of the functions in edible article 200 is also a shape of a disc-like flower with slits and raised center discs on both sides depicted in FIGS. 2A through 2D are able to interconnect on all permitting eight directions repeatedly in FIG. 2E, slit 202 mating with slit 202 at center of edible articles 201 also passing an elevated center of edible articles 208. While slit 202 to slit 202 interconnections are proper, the user is also permitted to use alternative methodologies of interconnection with slit 202 to tab 203 relationship. Edible articles 100 and 200 may interconnect when measurements are permissible and are not limited to other embodiments of this invention.

Third embodiment of the functions in edible article 300 is a shape of a five petals flower with slits in FIGS. 3A to 3D, slit 302 to slit 302 meeting at center of edible articles 301. While slit 302 to slit 302 operations are permitted, the user is allowed to act on alternative options of interconnection with slit 302 to tab 303 relationships.

Fourth and fifth embodiments of the functions in edible articles 400 and 500 are shapes of a sun in FIGS. 4, 4A, 5, and 5A may interconnect and are not limited to other embodiments of this invention. Slits 402, 405, 502, and 505, may liberally fit into each other meeting at centers of edible articles 401 or 501 and passing of an elevated center of edible articles 508. The user is also permitted to interconnect the edible articles in unorthodox methodologies; slits 402, 405, 502, and 505 to tabs 403 and 503 connections with or without passing the elevated center of edible articles 508 and with or without meeting at center of edible articles 401 or 501.

Sixth embodiment of the functions in edible article 600 is a shape of a triangle in FIGS. 6A and 6B may interconnect slits 602 and 605 to slits 602 and 605, they meet towards the center of edible articles 601. The user is also permitted to interconnect the edible articles from slits 602 and 605 to tab 603 and tabs may point into various directions towards or away from the center of edible articles 601.

Seventh embodiment of the functions in edible article 700 is a shape of a square in FIGS. 7A and 7B is permitted to interconnect slits 702 and 705 to slits 702 and 705 meeting towards the center of edible articles 701. The user is also allowed to interconnect the edible articles from slits 702 and 705 to tabs 703. Interconnections may occur towards or away from center of edible articles 701.

Eighth embodiment of the functions in edible article 800 is a shape of a semi-circle in FIGS. 8A and 8B is able to interconnect from slit 802 to slit 802 or slit 802 to tab 803 with or without meeting at center of edible article 801.

Ninth embodiment of the functions in edible articles 900 is a shape of a circular saw blade with angled slits in FIGS. 9A and 9B is able to interconnect from slit 902 to slit 902 or from slit 902 to tab 903 with or without meeting at center of edible articles 901. The slits are slightly angled away from the center of edible articles pointing towards the opposite off-center sides.

Tenth embodiment of the functions in edible article 1000 is a shape of a circular six petal flower in FIGS. 10A and 10B is able to interconnect from slit 1002 to slit 1002 or from slit 1002 to tab 1003 with or without meeting at center of edible articles 1001.

Eleventh embodiment of the functions in edible article 1100 is a shape of a six-armed star in 11A and 11B is able to interconnect from tab 1103 into slot 1102 repetitively in all six directions. The contours of tab 1103 in the positive and slot 1102 in the negative is preferably round but not limited to sharp, angular, straight, curved, or slightly curved lines.

Sizes of all embodiments may have same, similar, or dissimilar measurements. The criteria of slits in all embodiments are the same width in negative space as the thickness of tabs and central disc of food pieces. Slits of all embodiments also has options to have angular, straight, curved, or slightly curved edged grooves or sides for smooth insertion. Sizes of slits may vary, it may or may not correspond to interlocking with other embodiments of this invention.

Corners of tabs 106, 206, 306, 406, 506, 606, 706, 806, 906, and 1006 and the outer perimeter edge of tabs 103, 203, 303, 403, 503, 603, 705, 803, 903, 1003, and 1103 in all embodiments of this invention are not limited to sharp, rounded, or slightly curved contours. Tab thickness in the positive corresponds to fitting inside the width of slits in the negative space to hold one another. Sizes of tab thickness and widths of slits may vary, it may or may not correspond to interlocking with other embodiments of this invention.

Centered-disc elevated edges 208 and 508 may vary in sizes and forms. It may or may not correspond to interlocking with other embodiments of this invention

The components of the edible articles may be singular or in combination of more than one material. May include a variation of hardness, sweeteners, gelatinizing agents, edible oils, acidulants, emulsifiers, preservatives, colors, textures, flavors, glazing or coating agents.

The edible articles may have various of hardness ranges and textures. A selection of hardness ranges from solid to a hybrid or a soft finish depending on the composition of materials used in the production processes. Various output for edible articles are not limited to hard candy, soft candy, gummi candy, chocolate, cookies and biscuits, and etc. Also, gum, crackers, dry fruit and other materials may be used in this invention.

Sweeteners, artificial sweeteners, and sugarless sweeteners can be in the form of sucrose, dextrose, fructose, crystalline fructose, lactose, malt syrup, malt syrup solids, rice syrup, rice syrup solids, sorghum syrup, invert sugar, refiners syrup, corn syrup, corn syrup solids, maltose, high fructose corn syrup, honey, molasses, sugar alcohols, maltodextrin, sorbitol, xylitol, mannitol, galactitol, maltitol, hydrogenated isomaltulose (ISOMALT), lacitol, erythrytol, hydrogentated starch hydrolysate, stevia, lo han quo, dihydrochalcones, monellin, steviosides, rebaudioside, saccharin salts, cyclamate salts, and ammonium or calcium salts, or combinations thereof.

Embodiments may incorporate high intensity sweeteners as in sucralose, saccharin salts, acesulfame potassium, aspartame, thaumatin, monatin, neotame, alitame, and combination thereof.

Further materials may incorporate in the composition with fruit powder, drum-dried fruit solids, freeze-dried fruit solids, or evaporated fruit puree or fruit juice concentrate. May incorporate various non-sweetening agents as in salt, diary, wheat, or corn products. Various materials may be used in combination of mixing known components.

Any of a variety of active components may be included and in the present embodiments. These includes a variety of drugs as in medicaments or pharmaceutical actives, herbs, and nutritional supplements may optionally be encapsulated.

### Operation—FIGS. 1 to 10

In the present invention, the edible articles 100 through 1000 are able to interconnect from slit to slit or slit to tab systems interchangeably. The user is able to attach and detach confectionary pieces repetitively and is allowed to pivot into other frameworks of edible art. The user may eat before, during, and/or after constructing or deconstructing the frameworks respectively.

### Operation—FIG. 11

As shown in FIG. 11A, in this present invention, edible article 1100 is only permitted to interlock with identical confectionary pieces or the like from slot to tab in all directions permitted depicted in FIG. 11B.

### Advantages of the Invention

From the description above, a number of advantages of the embodiments of my food product becomes evident:
The embodiments of this inventions are interactive toy-like food products to build three-dimensional frameworks to reflect the imagination or idea of the patron. They may utilize one or more edible articles as means for articulating art concepts and designs.
Linking one or more embodiments of this invention is infinite and unlimited interlocking mechanism in any form.
Food pieces are playful, tangible, and edible art of the moment suitable for home, work, school, projects, and events.
Patrons may alter edible articles by breaking, biting, melting, or deform the intended shape or size. Also patrons may deform or reduce the size of slits, tabs, or slots. Patrons may also break off tabs or slots to redesign another edible article.
Edible articles have vast options of hardness, color, textures, flavor, and other methodologies of manufacture.

### CONCLUSION, RAMIFICATIONS, AND SCOPE

Accordingly, the reader will see that the various embodiments is interactive toy-like edible articles. The patron is able to articulate imaginations or ideas by piecing together complex, three-dimensional frameworks reflecting from within.
It permits all embodiments to fit into other embodiments unlimited and infinitely.
It allows production of edible articles into various one or more combinations of hardness, colors, materials, flavors, and etc.
It permits users to eat before, during, and/or after constructing or deconstructing the frameworks.
It permits patrons to manipulate edible articles by breaking, biting, melting, or deform the intended shape or size. Also patrons may redesign the edible articles by reducing the size of slits, tabs, or slots.

Although the description above contains many specificities, these should not be construed as limiting the scope of the embodiments. For example, the shapes and sizes of edible articles are not limited to trapezoidal, rectangular, animals, alphabets, etc.; The tabs and slits may have other linear patterns and compositions. Slits of all embodiments also has options to have angular, straight, curved, or slightly curved edged grooves or sides for smooth insertion. Sizes of slits may vary, it may or may not correspond to interlocking with other embodiments of this invention. Slits to slits and slits to tabs insertion is ideally linking perpendicular but not limited to linking at various directions and angles. One tab or sandwiched tabs of other embodiments may fit into perpendicular or at non-perpendicular angles linking to other embodiments of this invention.

Thus the scope of the embodiments should be determined by the appended claims and their legal equivalents, rather than by the examples given.

I claim:

1. An edible article assembly comprising a form with indentations is able to entirely or partially couple with other fitted singular or plurality of likewise or other forms of said edible articles.
Said edible articles of assembly are arrangeable to form complex frameworks.

2. An assembly as set forth in claim 1 wherein said plurality of edible articles of assembly are integrally engaged together so as to be separable from each other.

3. An assembly as set forth in claim 1 wherein said plurality of edible articles may or may not be able to engage or separable from each other.

4. An assembly as set forth in claim 1 wherein said edible articles may consist raised centered discs on one side or both sides of said edible article.

5. An assembly as set forth in claim 1 wherein said edible articles comprising singular or plurality of components in composition of varied outcomes in sizes, weight, hardness, mass, textures, colors, and flavors.
